(19) United States
(12) Patent Application Publication
(10) Pub. No.: US 2007/0160218 A1
(43) Pub. Date: Jul. 12, 2007

(54) Decoding of binaural audio signals

(75) Inventors: Julia Jakka, Espoo (FI); Pasi Ojala, Kirkkonummi (FI); Mauri Vaananen, Tampere (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/334,041

(22) Filed: Jan. 17, 2006

(30) Foreign Application Priority Data
Jan. 9, 2006 (FI) PCT/FI06/50014

(51) Int. Cl. H04R 5/00; H04R 5/02

(52) U.S. Cl. 381/22; 381/309

(57) ABSTRACT

A method for synthesizing a binaural audio signal, the method comprising: inputting a parametrically encoded audio signal comprising at least one combined signal of a plurality of audio channels and one or more corresponding sets of side information describing a multi-channel sound image; and applying a predetermined set of head-related transfer function filters to the at least one combined signal in proportion determined by the corresponding set of side information to synthesize a binaural audio signal. A corresponding parametric audio decoder, parametric audio encoder, computer program product, and apparatus for synthesizing a binaural audio signal are also described.

### CROSS-REFERENCE TO RELATED APPLICATION

This application claims priority under 35 USC §119 to International Patent Application No. PCT/FI2006/050014 filed on Jan. 9, 2006.

### FIELD OF THE INVENTION

The present invention relates to spatial audio coding, and more particularly to decoding of binaural audio signals.

### BACKGROUND OF THE INVENTION

In spatial audio coding, a two/multi-channel audio signal is processed such that the audio signals to be reproduced on different audio channels differ from one another, thereby providing the listeners with an impression of a spatial effect around the audio source. The spatial effect can be created by recording the audio directly into suitable formats for multi-channel or binaural reproduction, or the spatial effect can be created artificially in any two/multi-channel audio signal, which is known as spatialization.

It is generally known that for headphones reproduction artificial spatialization can be performed by HRTF (Head Related Transfer Function) filtering, which produces binaural signals for the listener's left and right ear. Sound source signals are filtered with filters derived from the HRTFs corresponding to their direction of origin. A HRTF is the transfer function measured from a sound source in free field to the ear of a human or an artificial head, divided by the transfer function to a microphone replacing the head and placed in the middle of the head. Artificial room effect (e.g. early reflections and/or late reverberation) can be added to the spatialized signals to improve source externalization and naturalness.

As the variety of audio listening and interaction devices increases, compatibility becomes more important. Amongst spatial audio formats the compatibility is striven through upmix and downmix techniques. It is generally known that there are algorithms for converting a multi-channel audio signal into stereo format, such as Dolby Digital® and Dolby Surround®, and for further converting a stereo signal into binaural signal. However, in this kind of processing the spatial image of the original multi-channel audio signal cannot be fully reproduced. A better way of converting a multi-channel audio signal for headphone listening is to replace the original loudspeakers with virtual loudspeakers by employing HRTF filtering and to play the loudspeaker channel signals through those (e.g. Dolby Headphone®). However, this process has the disadvantage that, for generating a binaural signal, a multi-channel mix is always first needed. That is, the multi-channel (e.g. 5+1 channels) signals are first decoded and synthesized, and HRTFs are then applied to each signal for forming a binaural signal. This is computationally a heavy approach compared to decoding directly from the compressed multi-channel format into binaural format.

Binaural Cue Coding (BCC) is a highly developed parametric spatial audio coding method. BCC represents a spatial multi-channel signal as a single (or several) downmixed audio channel and a set of perceptually relevant inter-channel differences estimated as a function of frequency and time from the original signal. The method allows for a spatial audio signal mixed for an arbitrary loudspeaker layout to be converted for any other loudspeaker layout, consisting of either the same or a different number of loudspeakers.

Accordingly, the BCC is designed for multi-channel loudspeaker systems. However, generating a binaural signal from a BCC processed mono signal and its side information requires that a multi-channel representation is first synthesised on the basis of the mono signal and the side information, and only then may it be possible to generate a binaural signal for spatial headphones playback from the multi-channel representation. It is apparent that this approach is not optimised in view of generating a binaural signal.

### SUMMARY OF THE INVENTION

Now there is invented an improved method and technical equipment implementing the method, by which generating a binaural signal is enabled directly from a parametrically encoded audio signal. Various aspects of the invention include a decoding method, a decoder, an apparatus, an encoding method, an encoder, and computer programs, which are characterized by what is stated in the independent claims. Various embodiments of the invention are disclosed in the dependent claims.

According to a first aspect, a method according to the invention is based on the idea of synthesizing a binaural audio signal such that a parametrically encoded audio signal comprising at least one combined signal of a plurality of audio channels and one or more corresponding sets of side information describing a multi-channel sound image is first inputted. Then a predetermined set of head-related transfer function filters are applied to the at least one combined signal in proportion determined by said corresponding set of side information to synthesize a binaural audio signal.

According to an embodiment, from the predetermined set of head-related transfer function filters, a left-right pair of head-related transfer function filters corresponding to each loudspeaker direction of the original multi-channel loudspeaker layout is chosen to be applied.

According to an embodiment, said set of side information comprises a set of gain estimates for the channel signals of the multi-channel audio, describing the original sound image.

According to an embodiment, the gain estimates of the original multi-channel audio are determined as a function of time and frequency; and the gains for each loudspeaker channel are adjusted such that the sum of the squares of each gain value equals one.

According to an embodiment, the at least one combined signal is divided into time frames of an employed frame length, which frames are then windowed; and the at least one combined signal is transformed into the frequency domain prior to applying the head-related transfer function filters.

According to an embodiment, the at least one combined signal is divided in the frequency domain into a plurality of psycho-acoustically motivated frequency bands, such as frequency bands complying with the Equivalent Rectangular Bandwidth (ERB) scale, prior to applying the head-related transfer function filters.

According to an embodiment, outputs of the head-related transfer function filters for each of said frequency band for a left-side signal and a right-side signal are summed up separately; and the summed left-side signal and the summed right-side signal are transformed into the time domain to create a left-side component and a right-side component of a binaural audio signal.

A second aspect provides a method for generating a parametrically encoded audio signal, the method comprising: inputting a multi-channel audio signal comprising a plurality of audio channels; generating at least one combined signal of the plurality of audio channels; and generating one or more corresponding sets of side information including gain estimates for the plurality of audio channels.

According to an embodiment, the gain estimates are calculated by comparing the gain level of each individual channel to the cumulated gain level of the combined signal.

The arrangement according to the invention provides significant advantages. A major advantage is the simplicity and low computational complexity of the decoding process. The decoder is also flexible in the sense that it performs the binaural synthesis completely on the basis of the spatial and encoding parameters given by the encoder. Furthermore, equal spatiality regarding the original signal is maintained in the conversion. As for the side information, a set of gain estimates of the original mix suffice. Most significantly, the invention enables enhanced exploitation of the compressive intermediate state provided in the parametric audio coding, improving efficiency in transmitting as well as in storing the audio.

The further aspects of the invention include various apparatuses arranged to carry out the inventive steps of the above methods.

### BRIEF DESCRIPTION OF THE DRAWINGS

In the following, various embodiments of the invention will be described in more detail with reference to the appended drawings, in which

FIG. 1 shows a generic Binaural Cue Coding (BCC) scheme according to prior art;

FIG. 2 shows the general structure of a BCC synthesis scheme according to prior art;

FIG. 3 shows a block diagram of the binaural decoder according to an embodiment of the invention; and

FIG. 4 shows an electronic device according to an embodiment of the invention in a reduced block chart.

### DESCRIPTION OF EMBODIMENTS

In the following, the invention will be illustrated by referring to Binaural Cue Coding (BCC) as an exemplified platform for implementing the decoding scheme according to the embodiments. It is, however, noted that the invention is not limited to BCC-type spatial audio coding methods solely, but it can be implemented in any audio coding scheme providing at least one audio signal combined from the original set of one or more audio channels and appropriate spatial side information.

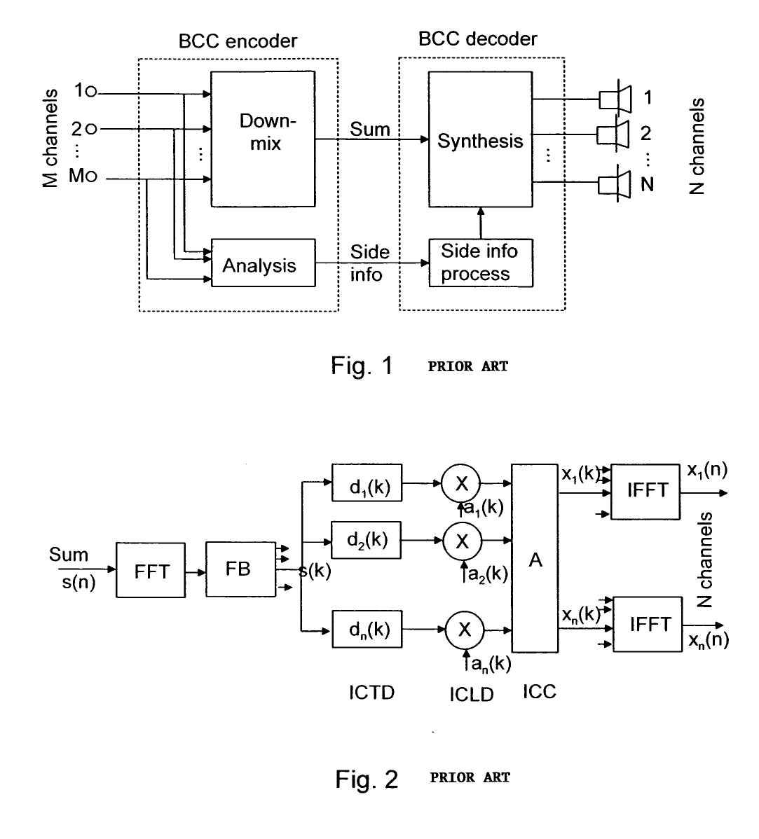

Binaural Cue Coding (BCC) is a general concept for parametric representation of spatial audio, delivering multi-channel output with an arbitrary number of channels from a single audio channel plus some side information. FIG. 1 illustrates this concept. Several (M) input audio channels are combined into a single output (S; “sum”) signal by a downmix process. In parallel, the most salient inter-channel cues describing the multi-channel sound image are extracted from the input channels and coded compactly as BCC side information. Both sum signal and side information are then transmitted to the receiver side, possibly using an appropriate low bitrate audio coding scheme for coding the sum signal. Finally, the BCC decoder generates a multi-channel (N) output signal for loudspeakers from the transmitted sum signal and the spatial cue information by re-synthesizing channel output signals, which carry the relevant inter-channel cues, such as Inter-channel Time Difference (ICTD), Inter-channel Level Difference (ICLD) and Inter-channel Coherence (ICC). Accordingly, the BCC side information, i.e. the inter-channel cues, is chosen in view of optimising the reconstruction of the multi-channel audio signal particularly for loudspeaker playback.

There are two BCC schemes, namely BCC for Flexible Rendering (type I BCC), which is meant for transmission of a number of separate source signals for the purpose of rendering at the receiver, and BCC for Natural Rendering (type II BCC), which is meant for transmission of a number of audio channels of a stereo or surround signal. BCC for Flexible Rendering takes separate audio source signals (e.g. speech signals, separately recorded instruments, multitrack recording) as input. BCC for Natural Rendering, in turn, takes a “final mix” stereo or multi-channel signal as input (e.g. CD audio, DVD surround). If these processes are carried out through conventional coding techniques, the bitrate scales proportionally or at least nearly proportionally to the number of audio channels, e.g. transmitting the six audio channels of the 5.1. multi-channel system requires a bitrate nearly six times of one audio channel. However, both BCC schemes result in a bitrate, which is only slightly higher than the bitrate required for the transmission of one audio channel, since the BCC side information requires only a very low bitrate (e.g. 2 kb/s).

FIG. 2 shows the general structure of a BCC synthesis scheme. The transmitted mono signal (“sum”) is first windowed in the time domain into frames and then mapped to a spectral representation of appropriate subbands by a FFT process (Fast Fourier Transform) and a filterbank FB. Instead of the processes in the FFT and FB, a QMF (Quadrature Mirror Filter) filter-bank process can be used to perform a decomposition of the signal. In the general case of playback channels the ICLD and ICTD are considered in each subband between pairs of channels, i.e. for each channel relative to a reference channel. The subbands are selected such that a sufficiently high frequency resolution is achieved, e.g. a subband width equal to twice the ERB scale (Equivalent Rectangular Bandwidth) is typically considered suitable. For each output channel to be generated, individual time delays ICTD and level differences ICLD are imposed on the spectral coefficients, followed by a coherence synthesis process which re-introduces the most relevant aspects of coherence and/or correlation (ICC) between the synthesized audio channels. Finally, all synthesized output channels are converted back into a time domain representation by an IFFT process (Inverse FFT), resulting in the multi-channel output. For a more detailed description of the BCC approach, a reference is made to: F. Baumgarte and C. Faller: “Binaural Cue Coding—Part I: Psychoacoustic Fundamentals and Design Principles”; IEEE Transactions on Speech and Audio Processing, Vol. 11, No. 6, November 2003, and to: C. Faller and F. Baumgarte: “Binaural Cue Coding—Part II: Schemes and Applications”, IEEE Transactions on Speech and Audio Processing, Vol. 11, No. 6, November 2003.

The BCC is an example of coding schemes, which provide a suitable platform for implementing the decoding scheme according to the embodiments. The binaural decoder according to an embodiment receives the monophonized signal and the side information as inputs. The idea is to replace each loudspeaker in the original mix with a pair of HRTFs corresponding to the direction of the loudspeaker in relation to the listening position. Each frequency channel of the monophonized signal is fed to each pair of filters implementing the HRTFs in the proportion dictated by a set of gain values, which can be calculated on the basis of the side information. Consequently, the process can be thought of as implementing a set of virtual loudspeakers, corresponding to the original ones, in the binaural audio scene. Accordingly, the invention adds value to the BCC by allowing for, besides multi-channel audio signals for various loudspeaker layouts, also a binaural audio signal to be derived directly from parametrically encoded spatial audio signal without any intermediate BCC synthesis process.

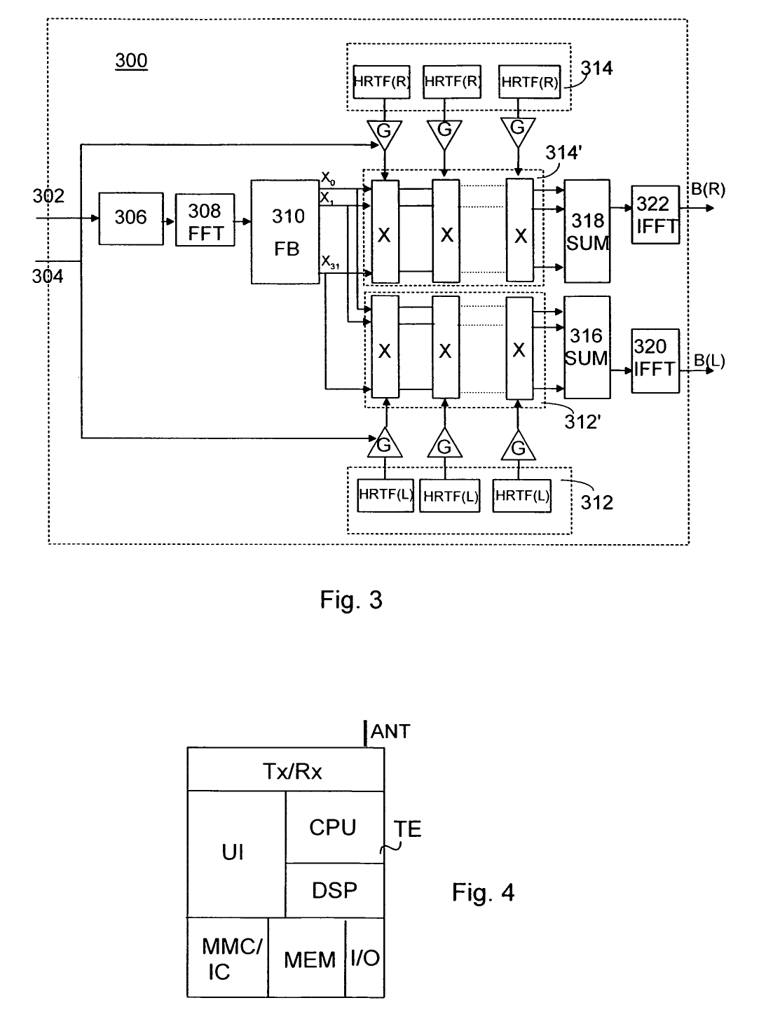

Some embodiments of the invention are illustrated in the following with reference to FIG. 3, which shows a block diagram of the binaural decoder according to an aspect of the invention. The decoder 300 comprises a first input 302 for the monophonized signal and a second input 304 for the side information. The inputs 302, 304 are shown as distinctive inputs for the sake of illustrating the embodiments, but a skilled man appreciates that in practical implementation, the monophonized signal and the side information can be supplied via the same input.

According to an embodiment, the side information does not have to include the same inter-channel cues as in the BCC schemes, i.e. Inter-channel Time Difference (ICTD), Inter-channel Level Difference (ICLD) and Inter-channel Coherence (ICC), but instead only a set of gain estimates defining the distribution of sound pressure among the channels of the original mix at each frequency band suffice. In addition to the gain estimates, the side information preferably includes the number and locations of the loudspeakers of the original mix in relation to the listening position, as well as the employed frame length. According to an embodiment, instead of transmitting the gain estimates as a part of the side information from an encoder, the gain estimates are computed in the decoder from the inter-channel cues of the BCC schemes, e.g. from ICLD.

The decoder 300 further comprises a windowing unit 306 wherein the monophonized signal is first divided into time frames of the employed frame length, and then the frames are appropriately windowed, e.g. sine-windowed. An appropriate frame length should be adjusted such that the frames are long enough for discrete Fourier-transform (DFT) while simultaneously being short enough to manage rapid variations in the signal. Experiments have shown that a suitable frame length is around 50 ms. Accordingly, if the sampling frequency of 44.1 kHz (commonly used in various audio coding schemes) is used, then the frame may comprise, for example, 2048 samples which results in the frame length of 46.4 ms. The windowing is preferably done such that adjacent windows are overlapping by 50% in order to smoothen the transitions caused by spectral modifications (level and delay).

Thereafter, the windowed monophonized signal is transformed into frequency domain in a FFT unit 308. The processing is done in the frequency domain in the objective of efficient computation. A skilled man appreciates that the previous steps of signal processing may be carried out outside the actual decoder 300, i.e. the windowing unit 306 and the FFT unit 308 may be implemented in the apparatus, wherein the decoder is included, and the monophonized signal to be processed is already windowed and transformed into frequency domain, when supplied to the decoder.

For the purpose of efficiently computing the frequency-domained signal, the signal is fed into a filter bank 310, which divides the signal into psycho-acoustically motivated frequency bands. According to an embodiment, the filter bank 310 is designed such that it is arranged to divide the signal into 32 frequency bands complying with the commonly acknowledged Equivalent Rectangular Bandwidth (ERB) scale, resulting in signal components x₀, . . . , x₃₁ on said 32 frequency bands. As an alternative for the blocks 306, 308 and 310, the time-frequency domain processing of the monophonized signal may be carried out in a QMF filter-bank unit performing the decomposition of the signal. A skilled man appreciates that in addition to a FFT processing or a QMF filter-bank processing, any other suitable method for carrying out the desired time-frequency domain processing can be used.

The decoder 300 comprises a set of HRTFs 312, 314 as pre-stored information, from which a left-right pair of HRTFs corresponding to each loudspeaker direction is chosen. For the sake of illustration, two sets of HRTFs 312, 314 is shown in FIG. 3, one for the left-side signal and one for the right-side signal, but it is apparent that in practical implementation one set of HRTFs will suffice. For adjusting the chosen left-right pairs of HRTFs to correspond to each loudspeaker channel sound level, the gain values G are preferably estimated. As mentioned above, the gain estimates may be included in the side information received from the encoder, or they may be calculated in the decoder on the basis of the BCC side information. Accordingly, a gain is estimated for each loudspeaker channel as a function of time and frequency, and in order to preserve the gain level of the original mix, the gains for each loudspeaker channel are preferably adjusted such that the sum of the squares of each gain value equals to one. This provides the advantage that, if N is the number of the channels to be virtually generated, then only N−1 gain estimates needs to be transmitted from the encoder, and the missing gain value can be calculated on the basis of the N−1 gain values. A skilled man, however, appreciates that the operation of the invention does not necessitate adjusting the sum of the squares of each gain value to be equal to one, but the decoder can scale the squares of the gain values such that the sum equals to one.

Then each left-right pair of the HRTF filters 312, 314 are adjusted in the proportion dictated by the set of gains G, resulting in adjusted HRTF filters 312′, 314′. Again it is noted that in practice the original HRTF filter magnitudes 312, 314 are merely scaled according to the gain values, but for the sake of illustrating the embodiments, “additional” sets of HRTFs 312′, 314′ are shown in FIG. 3.

For each frequency band, the mono signal components x₀, . . . , x₃₁ are fed to each left-right pair of the adjusted HRTF filters 312′, 314′. The filter outputs for the left-side signal and for the right-side signal are then summed up in summing units 316, 318 for both binaural channels. The summed binaural signals are sine-windowed again, and transformed back into time domain by an inverse FFT process carried out in IFFT units 320, 322. In case the analysis filters don't sum up to one, or their phase response is not linear, a proper synthesis filter bank is then preferably used to avoid distortion in the final binaural signals B_{R} and B_{L}. Again, if a QMF filter-bank unit is used in the decomposition of the signal as described above, the IFFT units 320, 322 are preferably replaced by IQMF (Inverse QMF) filter-bank units.

According to an embodiment, in order to enhance the externalization, i.e. out-of-the-head localisation, of the binaural signal, a moderate room response can be added to the binaural signal. For that purpose, the decoder may comprise a reverberation unit, located preferably between the summing units 316, 318 and the IFFT units 320, 322. The added room response imitates the effect of the room in a loudspeaker listening situation. The reverberation time needed is, however, short enough such that computational complexity is not remarkably increased.

The binaural decoder 300 depicted in FIG. 3 also enables a special case of a stereo downmix decoding, in which the spatial image is narrowed. The operation of the decoder 300 is amended such that each adjustable HRTF filter 312, 314, which in the above embodiments were merely scaled according to the gain values, are replaced by a predetermined gain. Accordingly, the monophonized signal is processed through constant HRTF filters consisting of a single gain multiplied by a set of gain values calculated on the basis of the side information. As a result, the spatial audio is down mixed into a stereo signal. This special case provides the advantage that a stereo signal can be created from the combined signal using the spatial side information without the need to decode the spatial audio, whereby the procedure of stereo decoding is simpler than in conventional BCC synthesis. The structure of the binaural decoder 300 remains otherwise the same as in FIG. 3, only the adjustable HRTF filter 312, 314 are replaced by downmix filters having predetermined gains for the stereo down mix.

If the binaural decoder comprises HRTF filters, for example, for a 5.1 surround audio configuration, then for the special case of the stereo downmix decoding the constant gains for the HRTF filters may be, for example, as defined in Table 1.

TABLE 1
HRTF filters for stereo down mix

| HRTF | Left | Right |
|---|---|---|
| Front left | 1.0 | 0.0 |
| Front right | 0.0 | 1.0 |
| Center | Sqrt (0.5) | Sqrt (0.5) |
| Rear left | Sqrt (0.5) | 0.0 |
| Rear right | 0.0 | Sqrt (0.5) |
| LFE | Sqrt (0.5) | Sqrt (0.5) |

The arrangement according to the invention provides significant advantages. A major advantage is the simplicity and low computational complexity of the decoding process. The decoder is also flexible in the sense that it performs the binaural upmix completely on basis of the spatial and encoding parameters given by the encoder. Furthermore, equal spatiality regarding the original signal is maintained in the conversion. As for the side information, a set of gain estimates of the original mix suffice. From the point of view of transmitting or storing the audio, the most significant advantage is gained through the improved efficiency when utilizing the compressive intermediate state provided in the parametric audio coding.

A skilled man appreciates that, since the HRTFs are highly individual and averaging is impossible, perfect re-spatialization could only be achieved by measuring the listener's own unique HRTF set. Accordingly, the use of HRTFs inevitably colorizes the signal such that the quality of the processed audio is not equivalent to the original. However, since measuring each listener's HRTFs is an unrealistic option, the best possible result is achieved, when either a modelled set or a set measured from a dummy head or a person with a head of average size and remarkable symmetry, is used.

As stated earlier, according to an embodiment the gain estimates may be included in the side information received from the encoder. Consequently, an aspect of the invention relates to an encoder for multichannel spatial audio signal that estimates a gain for each loudspeaker channel as a function of frequency and time and includes the gain estimations in the side information to be transmitted along the one (or more) combined channel. The encoder may be, for example, a BCC encoder known as such, which is further arranged to calculate the gain estimates, either in addition to or instead of, the inter-channel cues ICTD, ICLD and ICC describing the multi-channel sound image. Then both the sum signal and the side information, comprising at least the gain estimates, are transmitted to the receiver side, preferably using an appropriate low bitrate audio coding scheme for coding the sum signal.

According to an embodiment, if the gain estimates are calculated in the encoder, the calculation is carried out by comparing the gain level of each individual channel to the cumulated gain level of the combined channel; i.e. if we denote the gain levels by X, the individual channels of the original loudspeaker layout by “m” and samples by “k”, then for each channel the gain estimate is calculated as Xₘ(k)/X_{SUM}(k) Accordingly, the gain estimates determine the proportional gain magnitude of each individual channel in comparison to total gain magnitude of all channels.

According to an embodiment, if the gain estimates are calculated in the decoder on the basis of the BCC side information, the calculation may be carried out e.g. on the basis of the values of the Inter-channel Level Difference ICLD. Consequently, if N is the number of the “loudspeakers” to be virtually generated, then N−1 equations, comprising N−1 unknown variables, are first composed on the basis of the ICLD values. Then the sum of the squares of each loudspeaker equation is set equal to 1, whereby the gain estimate of one individual channel can be solved, and on the basis of the solved gain estimate, the rest of the gain estimates can be solved from the N−1 equations.

For example, if the number of the channels to be virtually generated is five (N=5), the N−1 equations may be formed as follows: L2=L1+ICLD1, L3=L1+ICLD2, L4=L1+ICLD3 and L5=L1+ICLD4. Then the sum of their squares is set equal to 1: L1²+(L1+ICLD1)²+(L1+ICLD2)²+(L1+ICLD3)²+(L1+ICLD4)²=1. The value of L1 can then be solved, and on the basis of L1, the rest of the gain level values L2-L5 can be solved.

For the sake of simplicity, the previous examples are described such that the input channels (M) are downmixed in the encoder to form a single combined (e.g. mono) channel. However, the embodiments are equally applicable in alternative implementations, wherein the multiple input channels (M) are downmixed to form two or more separate combined channels (S), depending on the particular audio processing application. If the downmixing generates multiple combined channels, the combined channel data can be transmitted using conventional audio transmission techniques. For example, if two combined channels are generated, conventional stereo transmission techniques may be employed. In this case, a BCC decoder can extract and use-the BCC codes to synthesize a binaural signal from the two combined channels.

According to an embodiment, the number (N) of the virtually generated “loudspeakers” in the synthesized binaural signal may be different than (greater than or less than) the number of input channels (M), depending on the particular application. For example, the input audio could correspond to 7.1 surround sound and the binaural output audio could be synthesized to correspond to 5.1 surround sound, or vice versa.

The above embodiments may be generalized such that the embodiments of the invention allow for converting M input audio channels into S combined audio channels and one or more corresponding sets of side information, where M>S, and for generating N output audio channels from the S combined audio channels and the corresponding sets of side information, where N>S, and N may be equal to or different from M.

Since the bitrate required for the transmission of one combined channel and the necessary side information is very low, the invention is especially well applicable in systems, wherein the available bandwidth is a scarce resource, such as in wireless communication systems. Accordingly, the embodiments are especially applicable in mobile terminals or in other portable device typically lacking high-quality loudspeakers, wherein the features of multi-channel surround sound can be introduced through headphones listening the binaural audio signal according to the embodiments. A further field of viable applications include teleconferencing services, wherein the participants of the teleconference can be easily distinguished by giving the listeners the impression that the conference call participants are at different locations in the conference room.

FIG. 4 illustrates a simplified structure of a data processing device (TE), wherein the binaural decoding system according to the invention can be implemented. The data processing device (TE) can be, for example, a mobile terminal, a PDA device or a personal computer (PC). The data processing unit (TE) comprises I/O means (I/O), a central processing unit (CPU) and memory (MEM). The memory (MEM) comprises a read-only memory ROM portion and a rewriteable portion, such as a random access memory RAM and FLASH memory. The information used to communicate with different external parties, e.g. a CD-ROM, other devices and the user, is transmitted through the I/O means (I/O) to/from the central processing unit (CPU). If the data processing device is implemented as a mobile station, it typically includes a transceiver Tx/Rx, which communicates with the wireless network, typically with a base transceiver station (BTS) through an antenna. User Interface (UI) equipment typically includes a display, a keypad, a microphone and connecting means for headphones. The data processing device may further comprise connecting means MMC, such as a standard form slot, for various hardware modules or as integrated circuits IC, which may provide various applications to be run in the data processing device.

Accordingly, the binaural decoding system according to the invention may be executed in a central processing unit CPU or in a dedicated digital signal processor DSP (a parametric code processor) of the data processing device, whereby the data processing device receives a parametrically encoded audio signal comprising at least one combined signal of a plurality of audio channels and one or more corresponding sets of side information describing a multi-channel sound image. The parametrically encoded audio signal may be received from memory means, e.g. a CD-ROM, or from a wireless network via the antenna and the transceiver Tx/Rx. The data processing device further comprises a suitable filter bank and a predetermined set of head-related transfer function filters, whereby the data processing device transforms the combined signal into frequency domain and applies a suitable left-right pairs of head-related transfer function filters to the combined signal in proportion determined by the corresponding set of side information to synthesize a binaural audio signal, which is then reproduced via the headphones.

Likewise, the encoding system according to the invention may as well be executed in a central processing unit CPU or in a dedicated digital signal processor DSP of the data processing device, whereby the data processing device generates a parametrically encoded audio signal comprising at least one combined signal of a plurality of audio channels and one or more corresponding sets of side information including gain estimates for the channel signals of the multi-channel audio.

The functionalities of the invention may be implemented in a terminal device, such as a mobile station, also as a computer program which, when executed in a central processing unit CPU or in a dedicated digital signal processor DSP, affects the terminal device to implement procedures of the invention. Functions of the computer program SW may be distributed to several separate program components communicating with one another. The computer software may be stored into any memory means, such as the hard disk of a PC or a CD-ROM disc, from where it can be loaded into the memory of mobile terminal. The computer software can also be loaded through a network, for instance using a TCP/IP protocol stack.

It is also possible to use hardware solutions or a combination of hardware and software solutions to implement the inventive means. Accordingly, the above computer program product can be at least partly implemented as a hardware solution, for example as ASIC or FPGA circuits, in a hardware module comprising connecting means for connecting the module to an electronic device, or as one or more integrated circuits IC, the hardware module or the ICs further including various means for performing said program code tasks, said means being implemented as hardware and/or software.

It is obvious that the present invention is not limited solely to the above-presented embodiments, but it can be modified within the scope of the appended claims.

What is claimed is:

1. A method for synthesizing a binaural audio signal, the method comprising:
inputting a parametrically encoded audio signal comprising at least one combined signal of a plurality of audio channels and one or more corresponding sets of side information describing a multi-channel sound image; and
applying a predetermined set of head-related transfer function filters to the at least one combined signal in proportion determined by said corresponding set of side information to synthesize a binaural audio signal.

2. The method according to claim 1, further comprising:
applying, from the predetermined set of head-related transfer function filters, a left-right pair of head-related transfer function filters corresponding to each loudspeaker direction of the original multi-channel audio.

3. The method according to claim 1, wherein
said set of side information comprises a set of gain estimates for the channel signals of the multi-channel audio describing the original sound image.

4. The method according to claim 3, wherein
said set of side information further comprises the number and locations of loudspeakers of the original multi-channel sound image in relation to a listening position, and an employed frame length.

5. The method according to claim 1, wherein
said set of side information comprises inter-channel cues used in a Binaural Cue Coding (BCC) scheme, such as Inter-channel Time Difference (ICTD), Inter-channel Level Difference (ICLD) and Inter-channel Coherence (ICC), the method further comprising:
calculating a set of gain estimates of the original multi-channel audio based on at least one of said inter-channel cues of the BCC scheme.

6. The method according to claim 3, further comprising:
determining the set of the gain estimates of the original multi-channel audio as a function of time and frequency; and
adjusting the gains for each loudspeaker channel such that the sum of the squares of each gain value equals one.

7. The method according to claim 1, further comprising:
dividing the at least one combined signal into time frames of an employed frame length, which frames are then windowed; and
transforming the at least one combined signal into the frequency domain prior to applying the head-related transfer function filters.

8. The method according to claim 7, further comprising:
dividing the at least one combined signal in the frequency domain into a plurality of psycho-acoustically motivated frequency bands prior to applying the head-related transfer function filters.

9. The method according to claim 8, further comprising:
dividing the at least one combined signal in the frequency domain into 32 frequency bands complying with the Equivalent Rectangular Bandwidth (ERB) scale.

10. The method according to claim 8, further comprising:
summing up outputs of the head-related transfer function filters for each of said frequency bands for a left-side signal and a right-side signal separately; and
transforming the summed left-side signal and the summed right-side signal into the time domain to create a left-side component and a right-side component of a binaural audio signal.

11. A method for synthesizing a stereo audio signal, the method comprising:
inputting a parametrically encoded audio signal comprising at least one combined signal of a plurality of audio channels and one or more corresponding sets of side information describing a multi-channel sound image; and
applying a set of downmix filters having predetermined gain values to the at least one combined signal in proportion determined by said corresponding set of side information to synthesize a stereo audio signal.

12. A parametric audio decoder, comprising:
a parametric code processor for processing a parametrically encoded audio signal comprising at least one combined signal of a plurality of audio channels and one or more corresponding sets of side information describing a multi-channel sound image; and
a synthesizer for applying a predetermined set of head-related transfer function filters to the at least one combined signal in proportion determined by said corresponding set of side information to synthesize a binaural audio signal.

13. The decoder according to claim 12, wherein
said synthesizer is arranged to apply, from the predetermined set of head-related transfer function filters, a left-right pair of head-related transfer function filters corresponding to each loudspeaker direction of the original multi-channel audio.

14. The decoder according to claim 12, wherein
said set of side information comprises a set of gain estimates for the channel signals of the multi-channel audio describing the original sound image.

15. The decoder according to claim 12, wherein
said set of side information comprises inter-channel cues used in a Binaural Cue Coding (BCC) scheme, such as Inter-channel Time Difference (ICTD), Inter-channel Level Difference (ICLD) and Inter-channel Coherence (ICC), the decoder being arranged to
calculate a set of gain estimates of the original multi-channel audio based on at least one of said inter-channel cues of the BCC scheme.

16. The decoder according to claim 12, further comprising:
means for dividing the at least one combined signal into time frames of an employed frame length,
means for windowing the frames; and
means for transforming the at least one combined signal into the frequency domain prior to applying the head-related transfer function filters.

17. The decoder according to claim 16, further comprising:
means for dividing the at least one combined signal in the frequency domain into a plurality of psycho-acoustically motivated frequency bands prior to applying the head-related transfer function filters.

18. The decoder according to claim 17, wherein:
said means for dividing the at least one combined signal in the frequency domain comprises a filter bank arranged to divide the at least one combined signal into 32 frequency bands complying with the Equivalent Rectangular Bandwidth (ERB) scale.

19. The decoder according to claim 17, further comprising:
a summing unit for summing up outputs of the head-related transfer function filters for each of said frequency band for a left-side signal and a right-side signal separately; and
a transforming unit for transforming the summed left-side signal and the summed right-side signal into time domain to create a left-side component and a right-side component of a binaural audio signal.

20. A parametric audio decoder, comprising:
a parametric code processor for processing a parametrically encoded audio signal comprising at least one combined signal of a plurality of audio channels and one or more corresponding sets of side information describing a multi-channel sound image; and
a synthesizer for applying a set of downmix filters having predetermined gain values to the at least one combined signal in proportion determined by said corresponding set of side information to synthesize a stereo audio signal.

21. A computer program product, stored on a computer readable medium and executable in a data processing device, for processing a parametrically encoded audio signal comprising at least one combined signal of a plurality of audio channels and one or more corresponding sets of side information describing a multi-channel sound image, the computer program product comprising:
a computer program code section for controlling transforming of the at least one combined signal into the frequency domain; and
a computer program code section for applying a predetermined set of head-related transfer function filters to the at least one combined signal in proportion determined by said corresponding set of side information to synthesize a binaural audio signal.

22. An apparatus for synthesizing a binaural audio signal, the apparatus comprising:
means for inputting a parametrically encoded audio signal comprising at least one combined signal of a plurality of audio channels and one or more corresponding sets of side information describing a multi-channel sound image;
means for applying a predetermined set of head-related transfer function filters to the at least one combined signal in proportion determined by said corresponding set of side information to synthesize a binaural audio signal; and
means for supplying the binaural audio signal in audio reproduction means.

23. The apparatus according to claim 22, said apparatus being a mobile terminal, a PDA device or a personal computer.

24. A method for generating a parametrically encoded audio signal, the method comprising:
inputting a multi-channel audio signal comprising a plurality of audio channels;
generating at least one combined signal of the plurality of audio channels; and
generating one or more corresponding sets of side information including gain estimates for the plurality of audio channels.

25. The method according to claim 24, further comprising:
calculating the gain estimates by comparing the gain level of each individual channel to the cumulated gain level of the combined signal.

26. The method according to claim 24, wherein
said set of side information further comprises the number and locations of loudspeakers of an original multi-channel sound image in relation to a listening position, and an employed frame length.

27. The method according to claim 24, wherein
said set of side information further comprises inter-channel cues used in a Binaural Cue Coding (BCC) scheme, such as Inter-channel Time Difference (ICTD), Inter-channel Level Difference (ICLD) and Inter-channel Coherence (ICC).

28. The method according to claim 24, further comprising:
determining the set of the gain estimates of the original multi-channel audio as a function of time and frequency; and
adjusting the gains for each loudspeaker channel such that the sum of the squares of each gain value equals one.

29. A parametric audio encoder for generating a parametrically encoded audio signal, the encoder comprising:
means for inputting a multi-channel audio signal comprising a plurality of audio channels;
means for generating at least one combined signal of the plurality of audio channels; and
means for generating one or more corresponding sets of side information including gain estimates for the plurality of audio channels.

30. The encoder according to claim 29, further comprising:
means for calculating the gain estimates by comparing the gain level of each individual channel to the cumulated gain level of the combined signal.

31. A computer program product, stored on a computer readable medium and executable in a data processing device, for generating a parametrically encoded audio signal, the computer program product comprising:
a computer program code section for inputting a multi-channel audio signal comprising a plurality of audio channels;
a computer program code section for generating at least one combined signal of the plurality of audio channels; and
a computer program code section for generating one or more corresponding sets of side information including gain estimates for the plurality of audio channels.
